(19) United States
(12) Patent Application Publication
(10) Pub. No.: US 2022/0087451 A1
(43) Pub. Date: Mar. 24, 2022

(54) Car Seat and Stroller Blanket

(71) Applicant: Christina Mae Morris, Beverly Hills, CA (US)

(72) Inventor: Christina Mae Morris, Beverly Hills, CA (US)

(21) Appl. No.: 17/460,645

(22) Filed: Aug. 30, 2021

Related U.S. Application Data
(60) Provisional application No. 63/080,020, filed on Sep. 18, 2020.

(51) Int. Cl. A47G 9/02

(52) U.S. Cl. CPC A47G 9/0223; B60R 22/105

(57) ABSTRACT

A car seat and stroller blanket to partially or fully cover a child seated in the child seat. The car seat and stroller blanket has a variety of one or more belt holes with reinforced stitching, in which the safety harness buckles are passed through the belt holes before being buckled into the safety harness.

The car seat and stroller blanket may include an accessory button tab placed on the back side of the blanket. The car seat and stroller blanket may also include a closable pouch for storing items of convenience within a covered zippered pouch. It also includes a pouch at the bottom of the car seat and stroller blanket for the child's feet to be placed in to provide additional warmth.

### PRIORITY

This application claims priority to Provisional Patent Application Ser. No. 63/080,020 filed on Sep. 18, 2020.

### BACKGROUND OF THE INVENTION

### Field of the Invention

Embodiments of the invention relate generally to coverings for child seats and more specifically to coverings that are useable with stroller seats, infant carriers, and car seats to safely cover or partially cover a child seated in a stroller seat, infant carrier or car seat without hindering safety or safety guidelines of not impeding the safety harness.

Child seats are designed to safely secure a child to protect the child during transportation and/or other activities. Child seats include infant carriers, car seats, car booster seats, strollers, and the like. Infant carriers and car seats are close in design and function, except that infant carriers are generally designed to removably couple with a base unit secured to a vehicle. The infant carriers may be conveniently removed from the base unit and transported while an infant or newborn remains restrained within the infant carrier.

Child seats are often designed to provide comfort for the child secured within the seat. Typically, these seats are made of a plastic or metal base (e.g., polypropylene base or tubing) and include fabric liners, padding (e.g., foam padding), constraint belts, buckles, handles, wheels, and the like. Child seats may also include other components, such as pockets, shade coverings, wheel locks, and the like. Additional components and/or attachments are often used with child seats, such as toys that hang from a handle or trays that attach to the child seat that support the child's food or drink.

Child seats may be used for children of various ages and size ranging from infants to school age children. The child seat may be adjustable so that the child seat may continue to be used as the child grows. When using child seats for newborns and infants, special care is often needed due to the fragile nature of the young children. For example, newborns and infants may get cold while riding in a stroller, infant carrier, or car seat because of their immobility and/or inability to generate enough body heat. Newborns and infants typically lack the ability to communicate when they are cold, uncomfortable, or in danger of suffocation due to fabric gathering around their face blocking their ability to breath. Further, placing a coat or jacket on the child to keep the child warm may render buckling the child within the child seat more difficult due to the additional bulky material and the bulky material impedes the safety harnesses from properly protecting the child from harm. For these and other reasons, it may be desirable to cover a child seated in a child seat to keep the child warm and/or comfortable while riding in the child seat.

### Description of Background Art

The prior art describes a number of potential, but inferior, solutions to the problems related to blankets for use with infants or children. Some references describe blankets that have slits for carrier straps but are placed under the child and wrapped around. These are problematic because the blanket can be thrown off by the child and get bunched up behind them.

Another type of design referenced in the prior art show zippered enclosures that go around the child. These limit the infant or child's movement and allow easy overheating.

Yet another style of device is similar to a sleeping bag or a sack for the child or infant, with slits to route the carrier straps. These designs often result in overheating of the child. Infants in particular cannot communicate when they are too hot or too cold. Further, these designs severely limit the child's range of movement, often result in a fussy or upset child.

### Objects of the Invention

It is an object of the invention to provide a baby blanket that is compatible for use with car seat or stroller straps.

It is an object of the invention to provide a baby blanket that lays on top of an infant or a child, while the child is in a carrier, and allows routing of the carrier straps through the blanket.

It is an object of the invention to provide a baby blanket that lays on top of an infant or child while in a carrier and is kept in place by the carrier straps.

It is an object of the invention to allow the infant or child to have the ability to move their arms and legs while covered with the blanket.

It is an object of the invention to provide a baby blanket it with at various belt hole configurations for routing carrier and stroller safety straps.

It is an object of the invention to provide belt holes that have been reinforced with stitching to prevent tearing.

It is an object of the invention to provide an accessory tab on the blanket.

It is an object of the invention to provide an accessory tab with a button.

It is an object of the invention to provide a foot pouch on the underside of the blanket.

It is an object of the invention to provide a zippered accessory pouch on the rear of the blanket.

It is an object of the invention to hide the zipper for the accessory pouch such that the zipper does not directly contact the child.

### SUMMARY OF THE INVENTION

Embodiments of the invention provide for a car seat and stroller blanket in varying sizes to partially or fully cover a child seated in the child seat. The car seat and stroller blanket has horizontal belt holes with reinforced stitching, in which the safety harness buckle is passed through the bottom hole and again through the top hole before being buckled into the safety harness. This solves the problem of keeping the child safe and warm, while not putting bulky fabric between the safety harness and child which would hinder its safety abilities. Only a strip of fabric goes behind the buckle to secure the car seat and stroller blanket in place while not hindering the safety capabilities of the safety harness straps. Having the blanket secured via the buckle passing through the holes prevents the blanket from bunching around the newborn and infants face helping to prevent a suffocation issue. The belt holes allow for enough blanket to cover the infant and newborn safely keeping them warm while keeping their faces clear of obstructions that may hinder their breathing. The securing of the car seat and stroller blanket through the belt holes also prevents the car seat and stroller blanket from falling of the child or being kicked off. This helps to protect the car seat and stroller blanket from being covered in germs and dirt on the ground or floor of the vehicle.

The car seat and stroller blanket may include an accessory button tab discreetly placed on the back side of the blanket with the button faced into the blanket so as not to rub the child or be uncomfortable in any way. The accessory button tab allows for accessories to be attached to the blanket such as a buckle securing strap, a pacifier, a plushie and the like. This accessory button tab secures the accessory attachment to the blanket creating endless possibilities of accessories which will increase the convenience and functionality of the car seat and stroller blanket.

The car seat and stroller blanket may also include a closable pouch for storing items of convenience within a covered zippered pouch. It also includes a pouch at the bottom of the car seat and stroller blanket for the child's feet to be placed in to provide additional warmth.

Another embodiment of the invention has strategically placed vertical holes which allow the buckle straps to pass through the blanket vertically so as to secure the blanket to booster seats that utilize the vehicle's traditional safety harnesses.

Another embodiment of the invention has a single hole located such that it aligns with the safety straps of a stroller.

### BRIEF DESCRIPTION OF THE DRAWINGS

FIG. 1 shows the blanket covering a child in a car seat.

FIG. 2 shows the blanket covering a child in a stroller.

FIG. 3 shows a detailed view of the blanket with accessory tab and belt holes visible.

FIG. 4 shows a detailed view of the accessory tab with button.

FIG. 5 shows a method for covering a child with the blanket.

FIG. 6 shows the blanket for covering a child in a stroller with horizontal holes.

FIG. 7 shows the blanket for covering a child in a stroller with both vertical and horizontal holes.

FIG. 8 shows the blanket for covering a child in a stroller with a single hole.

FIG. 9 shows the zipper of the zippered pouch.

FIG. 10 shows the foot pouch for the child's feet.

### DETAILED DESCRIPTION OF THE INVENTION

The following detailed description outlines the preferred embodiment of the claimed invention. There may be many other configurations that comport with the attached claim language and this description is in no way limiting to the scope of the invention.

Embodiments of the present invention provide for a car seat and stroller blanket and methods of using a car seat and stroller blanket. The car seat and stroller blanket may be used with an infant carrier, a car seat, a booster seat, a stroller, or any other child seat or carrier to cover or partially cover a child seated in the infant carrier, car seat, booster seat, stroller seat or other seat. The car seat and stroller blanket is particularly useful to safely cover an infant or newborn placed in the child seat to insulate the infant or newborn and keep them warm and comfortable while also protecting against potential suffocation. Although the figures illustrate and specification generally describes the car seat and stroller blanket being used with an infant carrier or stroller seat, it should be realized that the car seat and stroller blanket may be used with any seat that a child may be placed in. Further, it should be realized that while the specification generally describes an infant carrier, the description equally applies to other car seats that may not be removable from a vehicle and that may be used for toddlers. In addition, the car seat and stroller blanket may be used for other applications that do not include a child seat or carrier. For example, the car seat and stroller blanket may be used separately or independent of a child seat or carrier, such as when a child is wrapped in the car seat and stroller blanket for comfort and warmth and held by a parent or guardian.

The car seat and stroller blanket may be made of a breathable fabric material so that air and/or perspiration may flow through the blanket to the child. Further, the car seat and stroller blanket may include a single layer of fabric, multiple layers of fabric coupled together, a padding disposed or positions between multiple layers of fabric, an insulation liner coupled with a fabric, and the like. The fabric of the car seat and stroller blanket may also be water resistant to protect the child from rain, snow, or other moisture. Examples of materials that may be used as the fabric material include nylon, LYCRA, polyester, cotton, cotton-polyester blend, rayon, and the like. The car seat and stroller blanket may also include various attachment mechanisms or members that allow the blanket and buckles and the like to be coupled together. These and other features of the car seat and stroller blanket will be further realized with the reference to the figures.

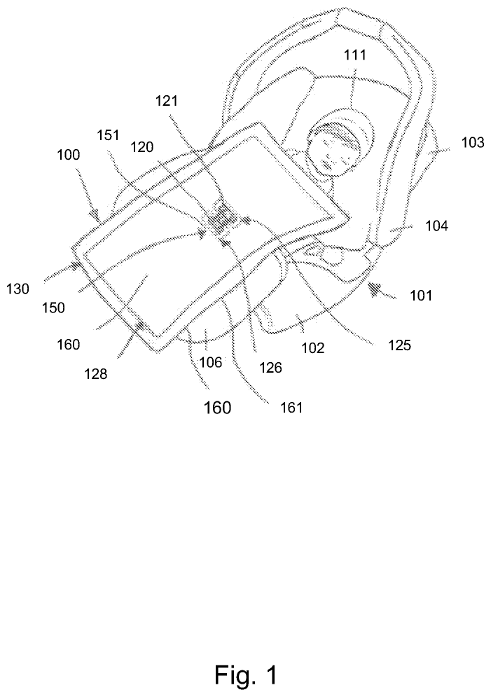

FIG. 1 illustrates a car seat and stroller blanket 100 fitted about or coupled with an infant carrier 101. The infant carrier 101 includes a base portion 102, which may be made of a plastic and/or metal material. The infant carrier 101 also includes a front portion 106 and a rear portion 103 that form a seat within which the child is placed. The infant carrier 101 also includes straps or belts (not shown) that buckle around the child to secure the child within the infant carrier 101. Typically, infant carriers 101 include a pair of shoulder belts (not shown) that are positions over the child's shoulders and arms. The shoulder belts are buckled to a lower belt and buckle that are placed between the child's legs. This buckle is passed through the strategically placed holes in the car seat and stroller blanket. The shoulder belts, lower belt and buckle form a 5-point harness mechanism that contacts the child's shoulders, hips, and groin to secure the child within the seat. The infant carrier may also include a chest clip (not shown) that couples the shoulder belts together in relation to the child's chest and that is vertically adjustable as the child grows. Likewise, the shoulder belts may be vertically adjusted in relation to the infant carrier 101 to account for the growth of a child. Infant carriers 101 also typically include a pull strap (not shown) that is used to tighten the 5-point harness when secured about the child. Alternately, the infant carrier may use restraint belts that are placed over the child's shoulders that couple with a buckle attached to a restraint belt placed between the child's legs.

The infant carrier 101 also includes a handle 104 that allows a parent, guardian, or other person to transport the infant carrier and child 111. The infant carrier 101 may also include various padding (not shown), fabric (not shown), and other features that are aesthetically pleasing and/or that comfort the child 111.

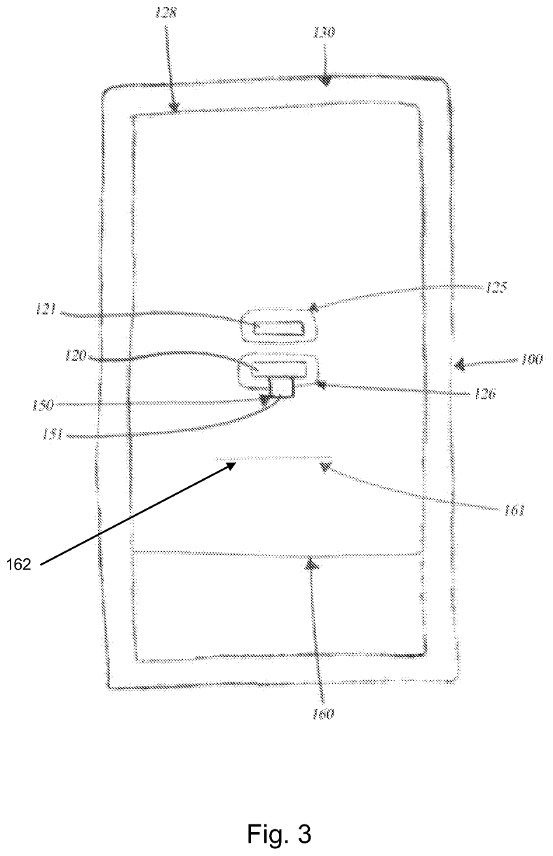

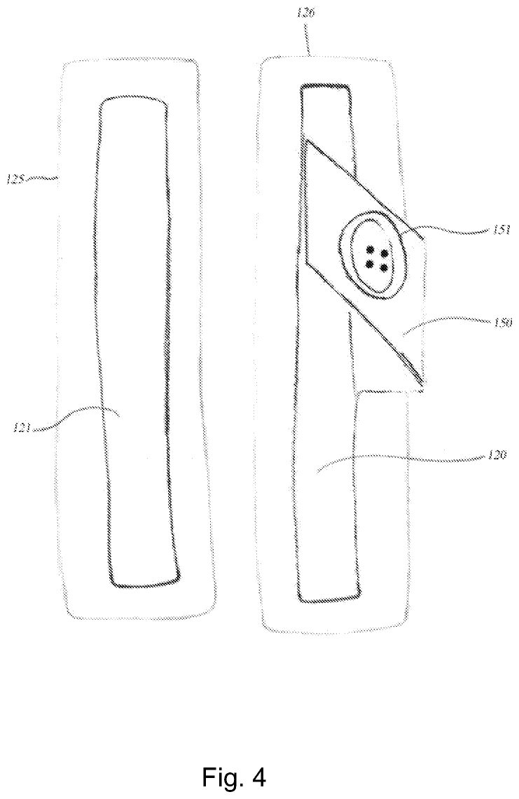

The car seat and stroller blanket 100 is fitted about or placed to partially or fully cover the child 111 seated in the infant carrier 101. The car seat and stroller blanket 100 has two belt holes for which the infant carrier 101 can be buckled through, the first belt hole 120 is the initial hole the infant carrier buckle is placed through. It is reinforced with reinforced stitching 126 to ensure it is secure and durable. The second belt hole 121 is through which the buckle passes back through allowing it to then buckle into the shoulder harness (not shown). It is reinforced with reinforced stitching 125 to ensure it is secure and durable. The edge of the car seat and stroller blanket 100 is wrapped in a satin ribbon 130 to reinforce the safe stability of the blanket while ensuring the child 111 is comfortable. This ribbon 130 is reinforced with durable stitching 128 to ensure it remains secure and safe. The car seat and stroller blanket 100 has an accessory tab 150 with an accessory securing button 151 secured to it. This is for attaching a variety of accessories such as a pacifier, a buckle securing band, a plushie toy or the like. A detailed view of accessory tab 150 and accessory securing button 151 is shown in FIGS. 3 and 4. A button is discussed and shown here, but any other suitable attachment methods such as snaps, Velcro, zippers or any other attachment method well known in the art could be used.

First belt hole 120 and second belt hole 121 may be oriented horizontally or vertically depending on the configuration of the straps for the given carrier.

Car seat and stroller blanket 100 is manufactured from any suitable baby blanket material including cotton and cotton blends, wool and wool blends, cashmere, cashmere blends, polyester, polyester blends, mylar, mylar blends, acrylic, acrylic blends, vellux, sherpa, woven and knitted fabrics, natural and man-made fabrics. It is manufactured using standard automated manufacturing methods well known in the bedding industry such as the cut and sew method. Materials can be cut manually or using automated methods, including laser cutting. Materials may also be sewn manually on a sewing machine or using automated sewing devices.

The preferred embodiment of the car seat and stroller blanket 100 includes a foot warmer pouch 160 in which the child's 111 feet can be placed to ensure they remain warm and dry. Another embodiment has a hidden zipper pouch 161 in which items can be placed and stored for convenience and quick access, while the hidden zipper allows it to remain smooth and comfortable against the child 111.

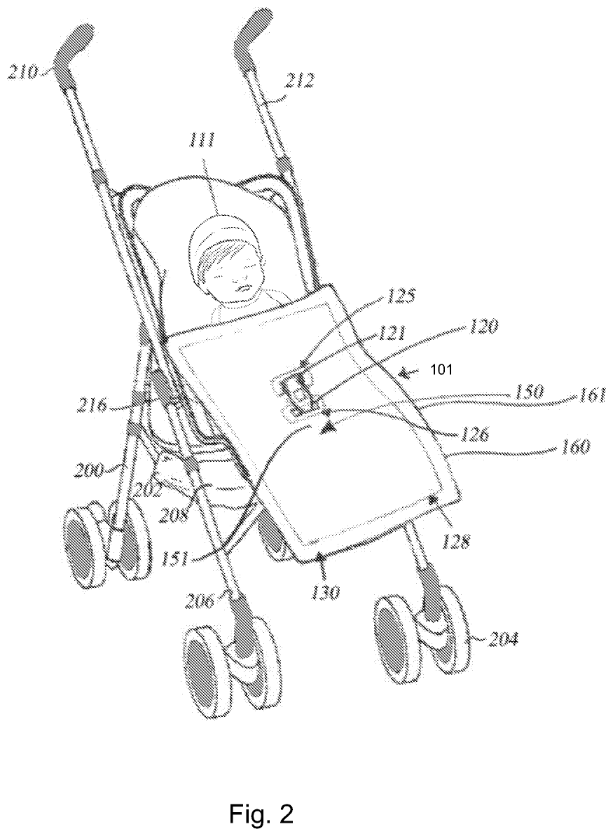

FIG. 2 illustrates the car seat and stroller blanket 100 fitted about or coupled with a stroller. The stroller includes a frame 200 and a seat 202 coupled to the frame 200. The frame 200 includes a plurality of legs 206 that each include one or more wheels 204 upon which the stroller rolls. Although FIG. 2 depicts the stroller including four legs that each include two wheels 204, the stroller may include less wheels and/or legs (e.g., three wheeled jogging strollers and the like). The seat 202 includes a bottom portion 208 upon which the child 111 sits and a back support 216 that supports the child's back.

The frame 200 or seat 202 may also include a shade covering (not shown) positioned above the child's head that folds open to partially cover and shade the child 111 or that folds up in an accordion like manner and is positioned adjacent the back support 216 when not being used. The frame 200 may also include a handle or pair of handles 210 that a user grasps to push the stroller. The handles 210 may be attached to the frame 200 via extension tubes 212. In one embodiment, the frame 200 is made of metal or plastic tubing. The frame 200 and/or seat 202 may be foldable to facilitate storage and/or transportation of the stroller. The stroller may also include straps or belts that buckle around the child 111 to secure the child 111 within the stroller. The belts or straps of the stroller may be similar to the 5-point harness of the infant carrier 101. Alternatively, the stroller's belts or straps may include a lap belt (not shown) that is placed around the child's waist and that couples to a buckle secured to a lower belt placed between the child's legs. Such a belt configuration would provide a 3-point harness that does not secure the child's shoulders against the stroller seat. The stroller may also include various padding (not shown), fabric (not shown), and other features that are aesthetically pleasing and/or that comfort the child 111. These various padding and fabric configurations are well known in the art.

The car seat and stroller blanket 100 is fitted about or coupled with the stroller to partially or fully cover the child 111 seated in the stroller. As described herein, the car seat and stroller blanket 100 is fitted about or placed to partially or fully cover the child 111 seated in the infant carrier 101. The car seat and stroller blanket 100 has two belt holes for which the infant carrier 101 can be buckled through, the first belt hole 120 is the initial hole the infant carrier buckle is placed through. It is reinforced with reinforced stitching 125 to ensure it is secure and durable. The second belt hole 121 is through which the buckle passes back through allowing it to then buckle into the shoulder harness (not shown). In this embodiment, first belt hole 120 and second belt hole 121 are oriented horizontally. Both belt holes are reinforced with reinforced stitching 125 to ensure they are secure and durable. The edge of the car seat and stroller blanket 100 is wrapped in a satin ribbon 130 to reinforce the safe stability of the blanket while ensuring the child 111 is comfortable. This ribbon 130 is reinforced with durable stitching 128 to ensure it remains secure and safe. The car seat and stroller blanket 100 has an accessory tab 150 with an accessory securing button 151 secured to it. This is for attaching a variety of accessories such as a pacifier, a buckle securing band, a plushie toy or the like.

The preferred embodiment of the car seat and stroller blanket 100, also has a foot warmer pouch 160 in which the child's 111 feet can be placed to ensure they remain warm and dry. Another embodiment has a hidden zipper pouch 161 in which items can be placed and stored for convenience and quick access, while the hidden zipper allows it to remain smooth and comfortable against the child 111.

FIG. 3 illustrates the back of the car seat and stroller blanket 100 with the accessory tab 150 on which the accessory securing button 151 is securely fastened on the rear (not shown) of the tab. This accessory tab 150 allows the attachment of a variety of accessories such as a pacifier, a buckle securing band, a plushie toy or the like. A button is discussed and shown here, but any other suitable attachment methods such as snaps, Velcro, zippers or any other attachment method well known in the art could be used.

The car seat and stroller blanket 100, has a foot warmer pouch 160 in which the child's 111 feet can be placed to ensure they remain warm and dry. The preferred embodiment also has a hidden zipper pouch 161 in which items can be placed and stored for convenience and quick access, while the hidden zipper allows it to remain smooth and comfortable against the child 111. The hidden zipper 162 is placed behind the fabric of the hidden zipper pouch 161 so the zipper will not contact the child 111. The car seat and stroller blanket 100 has two belt holes for which the infant carrier 101 can be buckled through, the first belt hole 120 is the initial hole the infant carrier buckle is placed up through. It is reinforced with reinforced stitching 125 to ensure it is secure and durable. The second belt hole 121 is through which the buckle passes back through allowing it to then buckle into the shoulder harness (not shown). It is reinforced with reinforced stitching 125 to ensure it is secure and durable. The edge of the car seat and stroller blanket 100 is wrapped in a satin ribbon 130 to reinforce the safe stability of the blanket while ensuring the child 111 is comfortable. This ribbon 130 is reinforced with durable stitching 128 to ensure it remains secure and safe.

FIG. 4 illustrates a close-up view of the accessory tab 150 on which the accessory securing button 151 is securely fastened. This tab allows the attachment of a variety of accessories such as a pacifier, a buckle securing band, a plushie toy or the like. The car seat and stroller blanket 100 has two belt holes for which the infant carrier 101 can be buckled through, the first belt hole 120 is the initial hole the infant carrier buckle is placed through. It is reinforced with reinforced stitching 126 to ensure it is secure and durable. The second belt hole 121 is through which the buckle passes back through allowing it to then buckle into the shoulder harness (not shown). It is reinforced with reinforced stitching 125 to ensure it is secure and durable.

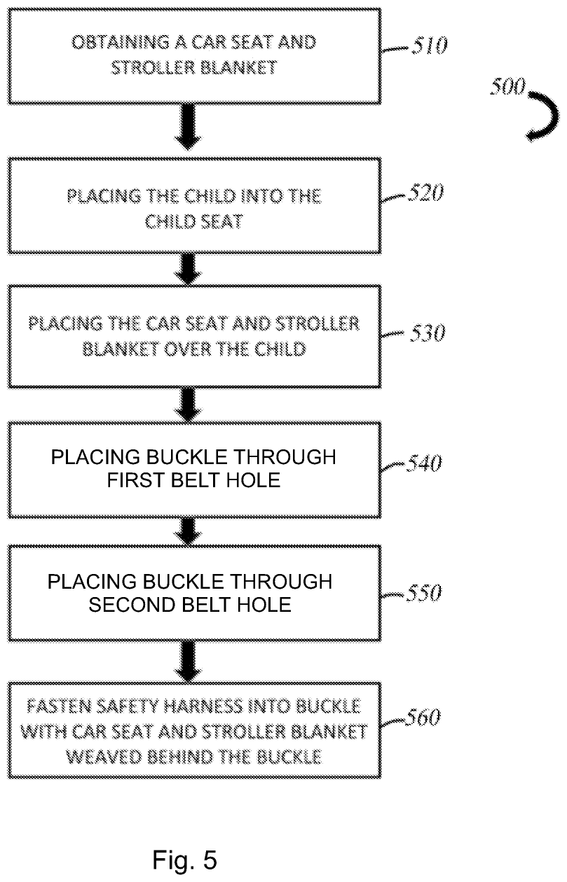

FIG. 5 illustrates a method 500 of covering a child positioned in a child seat with a car seat and stroller blanket. At block 510, a car seat and stroller blanket is obtained or provided. The car seat and stroller blanket may also include the accessory tab, the foot warmer pouch and the hidden zippered pouch. At block 520, the child is placed into the child seat (e.g., infant carrier, stroller seat, booster seat, and the like). At block 530, the car seat and stroller blanket is placed over the child. At block 540, the buckle of the car seat is placed up through the first belt hole. At block 550, the car seat buckle is placed back through the second belt and in block 560 the car seat buckle is fasted to the safety harness leaving a portion of the car seat and stroller blanket weaved behind the buckle. This allows the car seat and stroller blanket to be safely secured into place without compromising the safety harness and the safety of the child while allowing them to be warm and comfortable.

The method may additionally or alternatively include other steps not depicted in FIG. 5. For example, in the embodiment of the car seat and stroller blanket with belt holes to be used to secure booster seat car seats the steps would include putting the buckle through the belts holes 120 and 121 from left to right or right to left rather than from bottom to top. Similarly, the method may additionally include attaching attachments to the accessory tab 150 and accessory tab button 151. In addition, the method may include placing the child's feet into the foot warmth pouch 160 at the bottom of the car seat and stroller blanket. The use of the car seat and stroller blanket may also include several non-child seat or child carrier uses. For example, the car seat and stroller blanket may be used separately or independent of a child seat or carrier, such as when a child is placed within the car seat and stroller blanket for comfort and warmth and held by a parent or guardian. In such uses, the car seat and stroller blanket need not include the slots or openings that allow straps or belts to be positioned through the rear of the blanket.

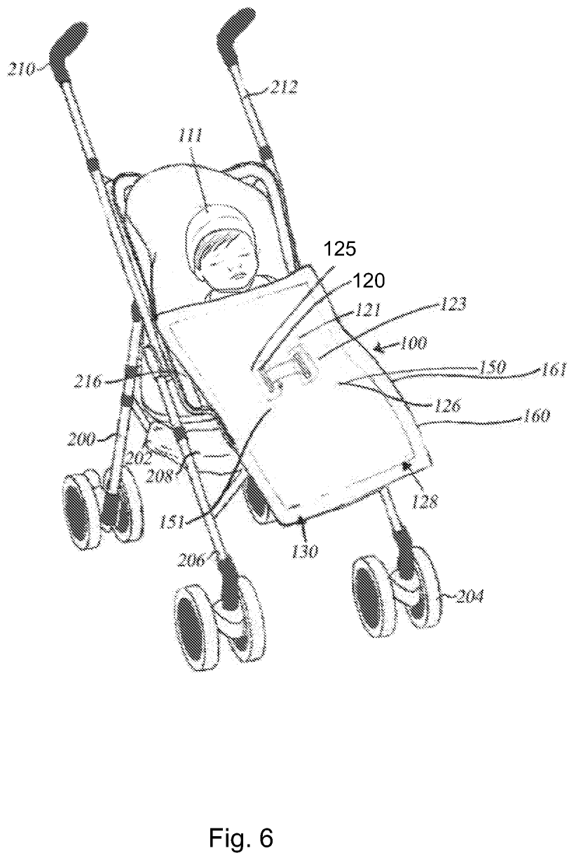

FIG. 6 illustrates the car seat and stroller blanket 100 with vertically oriented first belt hole 120 and second belt hole 121. In this embodiment, both belt holes are oriented vertically to accommodate safety straps that are best suited for this configuration. As in the other embodiments, both belt holes are reinforced with reinforced stitching 125 to ensure they are secure and durable. The edge of the car seat and stroller blanket 100 is wrapped in a satin ribbon 130 to reinforce the safe stability of the blanket while ensuring the child 111 is comfortable. This ribbon 130 is reinforced with durable stitching 128 to ensure it remains secure and safe. The car seat and stroller blanket 100 has an accessory tab 150 with an accessory securing button 151 secured to it. This is for attaching a variety of accessories such as a pacifier, a buckle securing band, a plushie toy or the like.

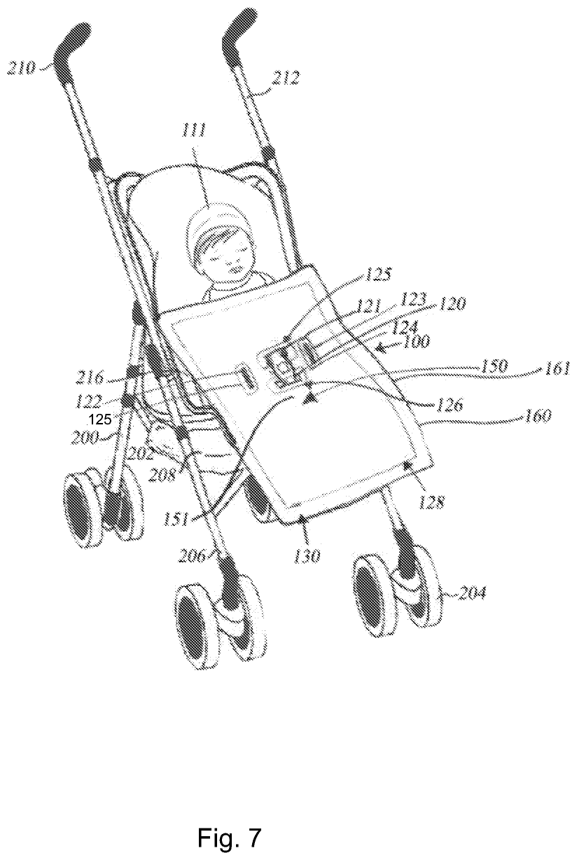

FIG. 7 illustrates a configuration of the car seat and stroller blanket 100 with both vertically and horizontally oriented belt holes. This configuration includes horizontally oriented first belt hole 120 and second belt hole 121. It further includes vertically oriented third belt hole 122 and fourth belt hole 123. This configuration allows for compatibility with the maximum number of car seats and strollers with multiple safety strap configurations. As in the other embodiments, all belt holes are reinforced with reinforced stitching 125 to ensure they are secure and durable.

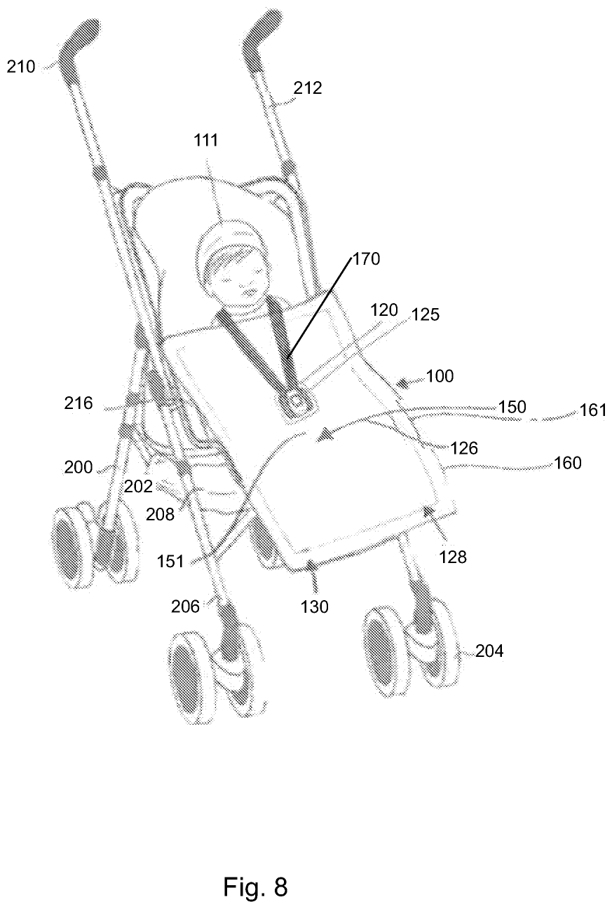

FIG. 8 shows a configuration of the car seat and stroller blanket 100 with a single belt hole. In this configuration, first belt hole 120 is oriented to be compatible with particular configurations of safety straps 170 for various car seats and strollers, specifically a stroller. The belt hole is reinforced with reinforced stitching 125 to ensure durability. This configuration allows the blanket to be used with a stroller, and secured with a first belt hole 120 with the safety straps 170 fed through the hole. Being secured in this way prevents the blanket from being kicked off or falling off while the child is in a stroller. It also ensures that the blanket stays covering the torso of the child or infant without bunching around their face, because the blanket is secured by safety straps 170 fed through first belt hole 120.

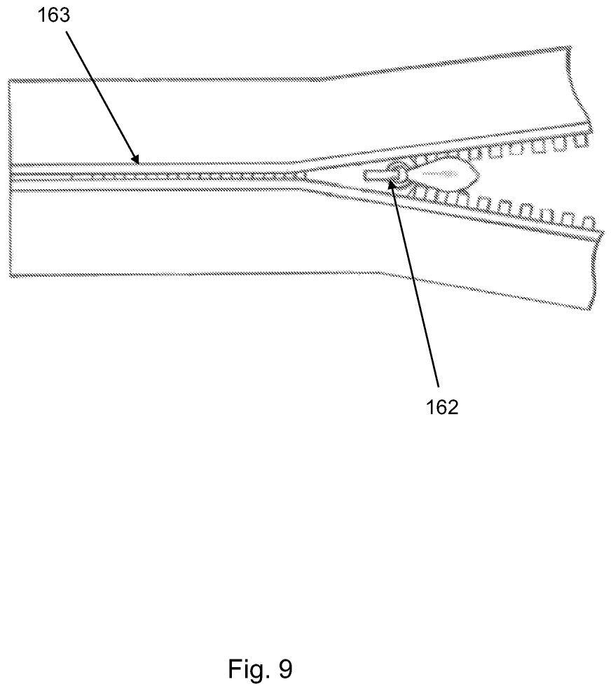

FIG. 9 shows detail of the hidden zipper 162 for hidden zipper pouch 161. In this view, fabric zipper protector 163 is visible. This fabric zipper protector 163 covers the metal of hidden zipper 162 so that the rough metal of the zipper does not come in contact with the delicate skin of the infant or child.

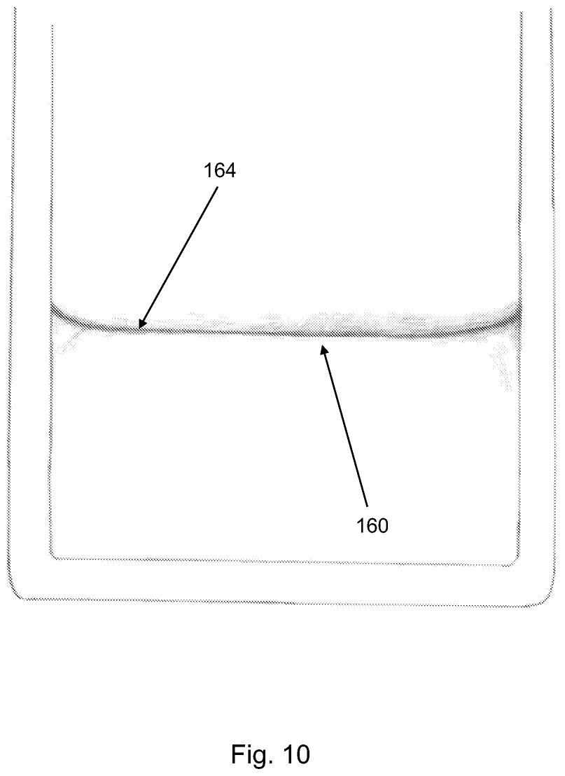

FIG. 10 shows detail of the foot warmer pouch 160. In this view, foot warmer pouch opening 164 extends along the bottom of the blanket, though different configurations of the foot warmer pouch 160 and foot warmer pouch opening 164 are anticipated by the invention. The infant or child slips their feet into the foot warmer pouch opening 164 and their feet are kept warm and dry while in the foot warmer pouch 160. The edge of foot warmer pouch opening 164 is reinforced with stitching to make it durable.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above detailed description and preferred embodiment should not be taken as liming the scope of the invention.

1. A blanket for placing over a child in a carrier comprising:
the blanket having at least a first belt hole surrounding a first opening in the blanket and a second belt hole surrounding a second opening in the blanket, the blanket further having a front side and a back side,
the carrier having at least a first strap and second strap, the first strap and second strap configured to secure the child in the carrier,
the first belt hole being oriented to allow the first strap to be placed through said first belt hole allowing the blanket to securely cover the child without interfering with the operation of the first strap, the first belt hole further being surrounded by stitching to prevent tearing of the blanket,
the second belt hole being oriented to allow the second strap to be placed through said second belt hole allowing the blanket to securely cover the child without interfering with the operation of the second strap, the second belt hole further being surrounded by stitching to prevent tearing of the blanket,
an accessory tab attached to the front side of the blanket, the accessory tab configured to allow attachment of accessories to the blanket, and
a pocket formed on the back side of the blanket, the pocket configured to fit over the feet of the child.

2. The blanket of claim 1, where the accessory tab further comprises a means for attaching items to the blanket.

3. The blanket of claim 1, where the accessory tab further comprises a button for attaching items to the blanket.

4. The blanket of claim 1, where the accessory tab further comprises a snap attachment.

5. The blanket of claim 1, where the accessory tab further comprises Velcro.

6. The blanket of claim 1 where the carrier is a car seat or stroller.

7. The blanket of claim 1 where the back of the blanket further comprises an accessory pouch with a zipper, where the zipper is disposed such that blanket material is between the child and the zipper.

8. The blanket of claim 1 where the outer edge of the blanket is comprised of a satin ribbon.

9. The blanket of claim 1 where the blanket is made of a material from the group comprising cotton, cotton blend, wool, wool blend, cashmere, cashmere blend, polyester, polyester blend, mylar, mylar blend, acrylic, acrylic blend, vellux, sherpa, and fleece.

10. The blanket of claim 1 where the first belt hole and second belt hole are oriented horizontally.

11. The blanket of claim 1 where the first belt hole and second belt hole are oriented vertically.

12. The blanket of claim 1 further comprising a third belt hole and a fourth belt hole, the third belt hole and fourth belt hole oriented to allow a safety strap of a carrier to be placed through each of the holes.

13. A blanket for placing over a child in a carrier comprising:
the blanket having a first belt hole surrounding a first opening in the blanket, the blanket further having a front side and a back side,
the carrier having at least a first strap, the first strap configured to secure the child in the carrier,
the first belt hole being oriented to allow the first strap to be placed through said first belt hole allowing the blanket to securely cover the child without interfering with the operation of the first strap, the first belt hole further being surrounded by stitching to prevent tearing of the blanket,
an accessory tab attached to the front side of the blanket, the accessory tab configured to allow attachment of accessories to the blanket, and
a pocket formed on the back side of the blanket, the pocket configured to fit over the feet of the child.

14. The blanket of claim 13, where the accessory tab further comprises a means for attaching items to the blanket.

15. The blanket of claim 13 where the carrier is a car seat or stroller.

16. The blanket of claim 13 where the back of the blanket further comprises an accessory pouch with a zipper, where the zipper is disposed such that blanket material is between the child and the zipper.

17. The blanket of claim 13 where the outer edge of the blanket is comprised of a satin ribbon.

18. The blanket of claim 13 where the blanket is made of a material from the group comprising cotton, cotton blend, wool, wool blend, cashmere, cashmere blend, polyester, polyester blend, mylar, mylar blend, acrylic, acrylic blend, vellux, sherpa, and fleece.

19. The blanket of claim 13 where the first belt hole is oriented horizontally.

20. The blanket of claim 13 where the first belt hole is oriented vertically.
